(19) United States
(12) Patent Application Publication
(10) Pub. No.: US 2026/0089731 A1
(43) Pub. Date: Mar. 26, 2026

(54) METHOD AND APPARATUS FOR ON DEMAND SYNCHRONIZATION SIGNAL BLOCK TRANSMISSION AND RECEPTION IN MOBILE WIRELESS COMMUNICATION SYSTEM

(71) Applicants: Soenghun Kim, Hanam-si (KR); BLACKPIN INC., Seoul (KR)

(72) Inventor: Soenghun Kim, Hanam-si (KR)

(21) Appl. No.: 19/328,933

(22) Filed: Sep. 15, 2025

(30) Foreign Application Priority Data
Sep. 26, 2024 (KR) 10-2024-0130511

(51) Int. Cl. H04W 72/231; H04W 48/08; H04W 76/27

(52) U.S. Cl. CPC H04W 72/231; H04W 48/08; H04W 76/27

(57) ABSTRACT

Aspects of the present disclosure are to address on-demand system information transmission. The method includes: receiving from the base station a radio resource control (RRC) message, wherein the RRC message includes one or more sets of configuration parameters for secondary cells; receiving from the base station, a specific Medium Access Control (MAC) Control Element (CE) related to activation of an on-demand Synchronization Signal Block (SSB); and determining based on the specific MAC CE activation of the on-demand SSB in a specific secondary cell. The specific secondary cell is determined based on first information of the specific MAC CE, wherein the first information is associated with a secondary cell index of the specific secondary cell. A specific number of bursts of the on-demand SSBs are transmitted in the secondary cell based on second information of the specific MAC CE.

### CROSS-REFERENCE TO RELATED APPLICATION

This application claims priority to and the benefit of Korean Patent Application No. 10-2024-0130511, filed on Sep. 26, 2024, the disclosure of which is incorporated herein by reference in its entirety.

### BACKGROUND

### Technical Field

The present disclosure relates to synchronization signal transmission for network energy efficiency in a mobile communication system.

### Related Art

To meet the increasing demand for wireless data traffic since the commercialization of 4th generation (4G) communication systems, the 5th generation (5G) system is being developed. 5G system introduced millimeter wave (mmW) frequency bands (e. g. 60 GHz bands). In order to increase the propagation distance by mitigating propagation loss in the 5G communication system, various techniques are introduced such as beamforming, massive multiple-input multiple output (MIMO), full dimensional MIMO (FD-MIMO), array antenna, analog beamforming, and large-scale antenna. In addition, base station is divided into a central unit and plurality of distribute units for better scalability.

In the advancement of 5G networks, one significant focus is improving network energy efficiency. A key innovation in this area is Synchronization Signal Block (SSB) transmission.

SSBs are critical components in 5G NR (New Radio) that carry essential information for cell search, signal synchronization, and initial access procedures. They enable User Equipment (UE) to discover and connect to the network.

Traditionally, SSBs are broadcast periodically at fixed intervals, regardless of whether any UEs are present or attempting to access the network.

Periodic transmission of SSBs degrades network energy efficiency especially in low load/traffic scenario.

### SUMMARY

Aspects of the present disclosure are to address on-demand system information transmission. The method includes: receiving from the base station a radio resource control (RRC) message, wherein the RRC message includes one or more sets of configuration parameters for secondary cells; receiving from the base station, a specific Medium Access Control (MAC) Control Element (CE) related to activation of an on-demand Synchronization Signal Block (SSB); and determining based on the specific MAC CE activation of the on-demand SSB in a specific secondary cell. The specific secondary cell is determined based on first information of the specific MAC CE, wherein the first information is associated with a secondary cell index of the specific secondary cell. A specific number of bursts of the on-demand SSBs are transmitted in the secondary cell based on second information of the specific MAC CE.

### BRIEF DESCRIPTION OF THE DRAWINGS

FIG. 1 is a diagram illustrating the architecture of an 5G system and a NG-RAN;

FIG. 2 is a diagram illustrating a wireless protocol architecture in an 5G system;

FIG. 3 illustrates the overall operation of the UE and network.

FIG. 4 illustrates RRC connection reconfiguration procedure.

FIG. 5 illustrates SS/PBCH block.

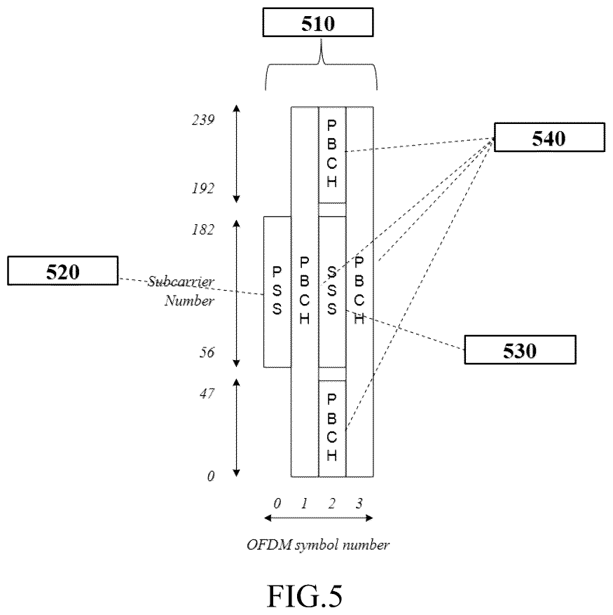

FIG. 6 illustrates the operation of the UE and network for SSB-less SCell.

FIG. 7 illustrates the operation of the UE and network for on-demand SSB.

FIG. 8 illustrates the format of OD-SSB activation/deactivation MAC CE.

FIG. 9 is a diagram illustrating UE operations for on-demand SSB.

FIG. 10 is a diagram illustrating base station operations for on-demand SSB.

FIG. 11 is a block diagram illustrating the internal structure of a UE to which the disclosure is applied.

FIG. 12 is a block diagram illustrating the configuration of a base station according to the disclosure.

### DETAILED DESCRIPTION

SSBs are critical components in 5G NR (New Radio) that carry essential information for cell search, signal synchronization, and initial access procedures. They enable User Equipment (UE) to discover and connect to the network.

Traditionally, SSBs are broadcast periodically at fixed intervals, regardless of whether any UEs are present or attempting to access the network, which results in unnecessary network energy consumption. One solution to remedy this problem is demand-driven SSB transmission.

On-demand SSB transmission represents a significant step towards sustainable and efficient 5G networks. By aligning signal transmissions with actual demand, networks can drastically reduce energy consumption without compromising connectivity. This approach not only benefits network operators through cost savings but also supports global efforts in reducing the carbon footprint of telecommunications infrastructure. To enable demand driven SSB transmission, new hardware, signaling and protocol are required.

Hereinafter, embodiments of the present disclosure will be described in detail with reference to the accompanying drawings. In addition, in the description of the present disclosure, if it is determined that a detailed description of a related known function or configuration may unnecessarily obscure the gist of the present disclosure, the detailed description thereof will be omitted. In addition, the terms to be described later are terms defined in consideration of functions in the present disclosure, which may vary according to intentions or customs of users and operators. Therefore, the definition should be made based on the content throughout this specification.

The terms used, in the following description, for indicating access nodes, network entities, messages, interfaces between network entities, and diverse identity information is provided for convenience of explanation. Accordingly, the terms used in the following description are not limited to specific meanings but may be replaced by other terms equivalent in technical meanings.

In the following descriptions, the terms and definitions given in the 3GPP standards are used for convenience of explanation. However, the present disclosure is not limited by use of these terms and definitions and other arbitrary terms and definitions may be employed instead.

In the present disclosure, “trigger” or “triggered” and “initiate” or “initiated” can be used interchangeably.

In the present disclosure, UE and terminal and wireless device can be used interchangeably. In the present disclosure, NG-RAN node and base station and GNB can be used interchangeably.

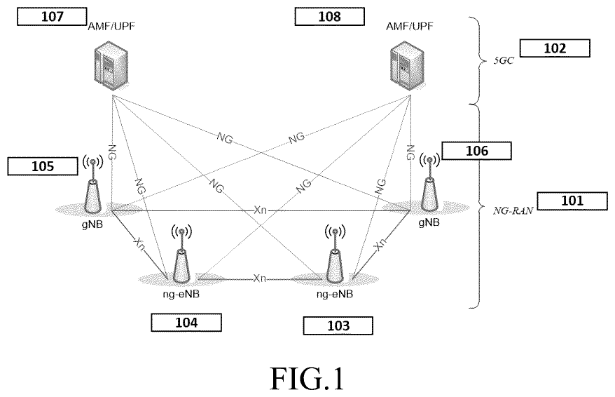

FIG. 1 is a diagram illustrating the architecture of an 5G system and a NG-RAN to which the disclosure may be applied.

G system consists of NG-RAN 101 and 5GC 102. An NG-RAN node is either:
>1: a gNB, providing NR user plane and control plane protocol terminations towards the UE; or
>1: an ng-eNB, providing E-UTRA user plane and control plane protocol terminations towards the UE.

The gNBs 105 or 106 and ng-eNBs 103 or 104 are interconnected with each other by means of the Xn interface. The gNBs and ng-eNBs are also connected by means of the NG interfaces to the 5GC, more specifically to the AMF (Access and Mobility Management Function) and to the UPF (User Plane Function). AMF 107 and UPF 108 may be realized as a physical node or as separate physical nodes.

A gNB 105 or 106 or an ng-eNBs 103 or 104 hosts the various functions listed below.
>1: Functions for Radio Resource Management such as Radio Bearer Control, Radio Admission Control, Connection Mobility Control, Dynamic allocation of resources to UEs in uplink, downlink and sidelink (scheduling); and
>1: IP and Ethernet header compression, uplink data decompression and encryption of user data stream; and
>1: Selection of an AMF at UE attachment when no routing to an MME can be determined from the information provided by the UE; and
>1: Routing of User Plane data towards UPF; and
>1: Scheduling and transmission of paging messages; and
>1: Scheduling and transmission of broadcast information (originated from the AMF or O&M); and
>1: Measurement and measurement reporting configuration for mobility and scheduling; and
>1: Session Management; and
>1: QOS Flow management and mapping to data radio bearers; and
>1: Support of UEs in RRC_INACTIVE state; and

The AMF 107 hosts the functions such as NAS signaling, NAS signaling security, AS security control, SMF selection, Authentication, Mobility management and positioning management.

The UPF 108 hosts the functions such as packet routing and forwarding, transport level packet marking in the uplink, QoS handling and the downlink, mobility anchoring for mobility etc.

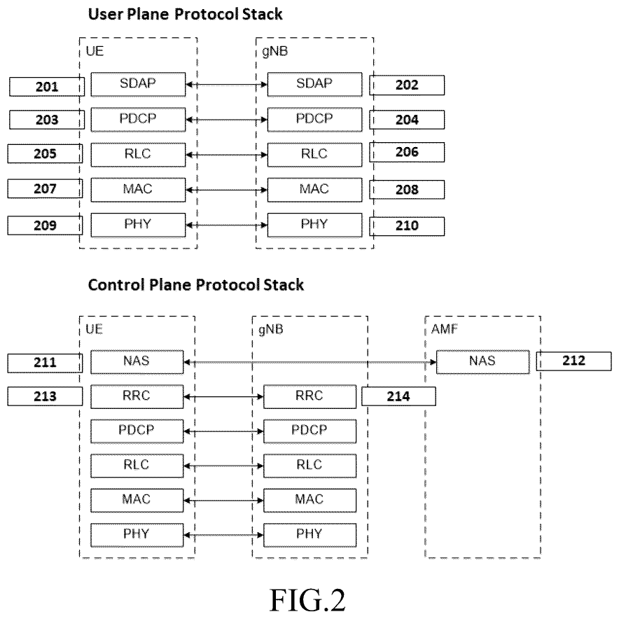

FIG. 2 is a diagram illustrating a wireless protocol architecture in an 5G system to which the disclosure may be applied.

The user plane protocol stack consists of SDAP 201 or 202, PDCP 203 or 204, RLC 205 or 206, MAC 207 or 208 and PHY 209 or 210. The control plane protocol stack consists of NAS 211 or 212, RRC 213 or 214, PDCP, RLC, MAC and PHY.

Each protocol sublayer performs functions related to the operations listed below.
NAS: authentication, mobility management, security control etc.
RRC: System Information, Paging, Establishment, maintenance and release of an RRC connection, Security functions, Establishment, configuration, maintenance and release of Signalling Radio Bearers (SRBs) and Data Radio Bearers (DRBs), Mobility, QoS management, Detection of and recovery from radio link failure, NAS message transfer etc.
SDAP: Mapping between a QoS flow and a data radio bearer, Marking QoS flow ID (QFI) in both DL and UL packets.
PDCP: Transfer of data, Header compression and decompression, Ciphering and deciphering, Integrity protection and integrity verification, Duplication, Reordering and in-order delivery, Out-of-order delivery etc.
RLC: Transfer of upper layer PDUs, Error Correction through ARQ, Segmentation and re-segmentation of RLC SDUs, Reassembly of SDU, RLC re-establishment etc.
MAC: Mapping between logical channels and transport channels, Multiplexing/demultiplexing of MAC SDUs belonging to one or different logical channels into/from transport blocks (TB) delivered to/from the physical layer on transport channels, Scheduling information reporting, Priority handling between UEs, Priority handling between logical channels of one UE etc.
PHY: Channel coding, Physical-layer hybrid-ARQ processing, Rate matching, Scrambling, Modulation, Layer mapping, Downlink Control Information, Uplink Control Information etc.

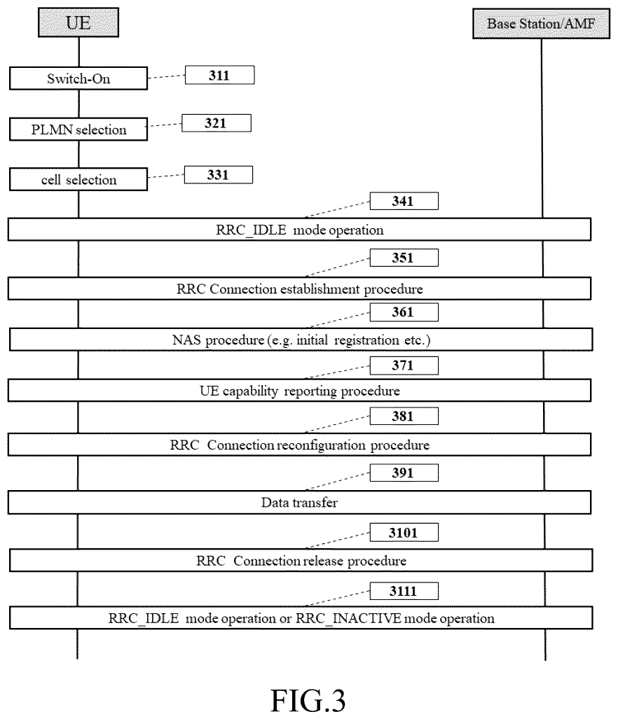

FIG. 3 illustrates overall operation of the UE and network.

Upon switch-on of the wireless device (e.g. UE) 311, UE performs PLMN selection 321 to select the carrier that is provided by the PLMN that UE is allowed to register.

Then UE performs cell selection 331 to camp on a suitable cell.

Once camping on a suitable cell, UE performs RRC_IDLE mode operation 341 such as paging channel monitoring and cell reselection and system information acquisition.

UE performs RRC Connection establishment procedure 351 to perform e.g. NAS procedure such as initial registration with the selected PLMN.

After successful RRC connection establishment, UE performs NAS procedure 361 by transmitting a corresponding NAS message via the established RRC connection (e.g. SRB1).

The base station can trigger UE capability reporting procedure 371 before configuring data bearers and various MAC functions.

The base station and the UE perform RRC connection reconfiguration procedure 381. Via the procedure, data radio bearers and logical channels and various MAC functions (such as DRX and BSR and PHR and beam failure reporting etc.) and various RRC functions (such as RRM and RLM and measurement etc.) are configured.

The base station and the UE perform data transfer 391 via the established radio bearers and based on configured MAC functions and configured RRC functions.

If geographical location of UE changes such that e.g. the current serving cell is no longer providing suitable radio condition, the base station and the UE perform cell level mobility such as handover or conditional reconfiguration or lower layer triggered mobility.

When RRC connection is no longer needed for the UE because of e.g. no more traffic available for the UE, the base station and the UE perform RRC connection release procedure 3101. The base station can transit UE state either to RRC_IDLE (if the data activity of the UE is expected low) or to RRC_INACTIVE (if the data activity of the UE is expected high).

The UE performs either RRC_IDLE operation or RRC_INACTIVE mode operation 3111 until the next event to RRC connection establishment/resumption occurs.

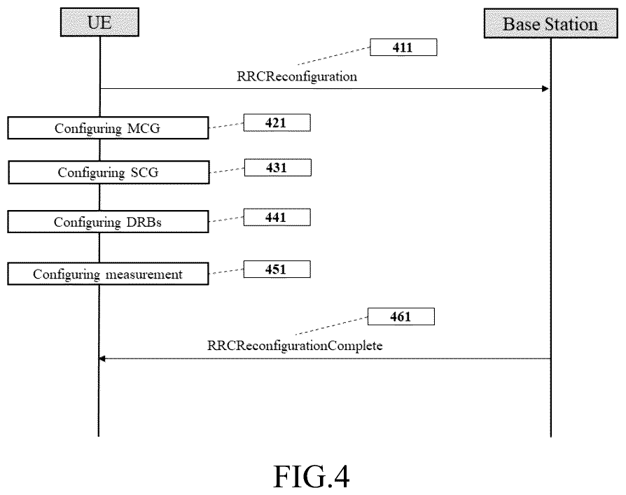

FIG. 4 illustrates RRC connection reconfiguration procedure.

Based on the reported capability and other factors such as required QoS and call admission control etc, the base station performs RRC reconfiguration procedure with the UE.

RRC reconfiguration procedure is a general purposed procedure that are applied to various use cases such as data radio bearer establishment, handover, cell group reconfiguration, DRX configuration, security key refresh and many others.

RRC reconfiguration procedure consists of exchanging RRCReconfiguration 411 and RRCReconfigurationComplete 461 between the base station and the UE.

RRCReconfiguration may comprise following fields and IEs:
>1: rrc-TransactionIdentifier field contains a RRC-TransactionIdentifier IE;
>1: radioBearerConfig field contains a RadioBearerConfig IE;
>>2: radioBearerConfig field comprises configuration information for SRBs and DRBs via which RRC messages and user traffic are transmitted and received;
>1: secondaryCellGroup field contains a CellGroupConfig IE;
>>2: secondaryCellGroup field comprises configuration information for secondary cell group;
>>2: A cell group consists of a SpCell and zero or more SCells;
>>2: Cell group configuration information comprises cell configuration information for SpCell/SCell and configuration information for MAC and configuration information for logical channel etc;
>1: measConfig field contains a MeasConfig IE;
>>2: measConfig field comprises configuration information for measurements that the UE is required to perform for mobility and other reasons.
>1: masterCellGroup field contains a CellGroupConfig IE;

Upon reception of RRCReconfiguration, UE processes the IEs in the order as below. UE may:
>1: perform the cell group configuration for MCG based on the received masterCellGroup 421;
>1: perform the cell group configuration for SCG based on the received secondaryCellGroup 431;
>1: perform the radio bearer configuration based on the received radioBearerConfig 441;
>1: perform the measurement configuration based on the received measConfig 451;

After performing configuration based on the received IEs/fields, the UE transmits the RRCReconfigurationComplete to the base station. To indicate that the RRCReconfigurationComplete is the response to RRCReconfiguration, UE sets the TransactionIdentifier field of the RRCReconfigurationComplete with the value indicated in TransactionIdentifier field of the RRCReconfiguration.

The Synchronization Signal and PBCH block (SSB) 510 consists of primary synchronization signals (PSS) 520 and secondary synchronization signals (SSS) 530. PSS and SSS occupies 1 symbol and 127 subcarriers. PBCH 540 spans across 3 OFDM symbols and 240 subcarriers The possible time locations of SSBs within a half-frame are determined by sub-carrier spacing and the periodicity of the half-frames where SSBs are transmitted is configured by the network. During a half-frame, different SSBs may be transmitted in different spatial directions (i.e. using different beams, spanning the coverage area of a cell).

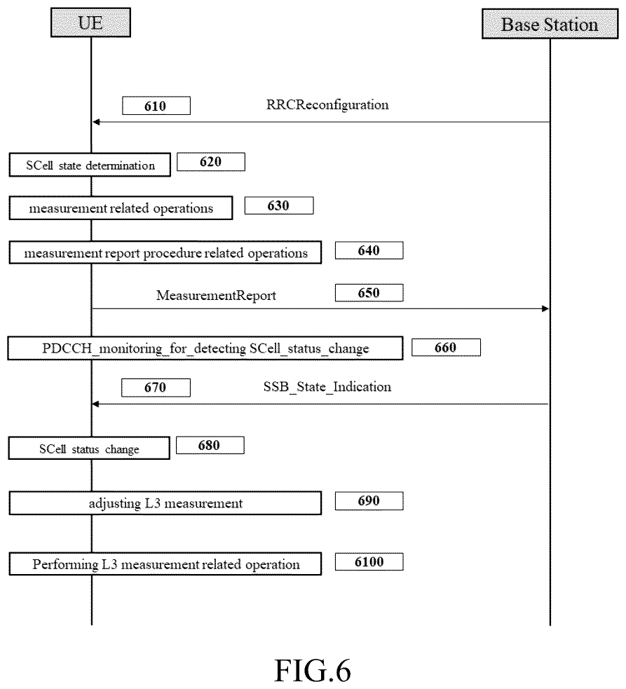

FIG. 6 illustrates the operations for SSB-less SCell that operates in a demand-driven manner.

In Rel-18 NES, SSB-less SCell operation is limited to the scenario of inter-band CA for FR1 and co-located cells.

In the Rel-18 NES, for SSB-less SCell to work properly, at least one SCell having similar radio characteristics and similar geographical condition is required to transmit SSB continuously. Then UE performs the necessary operation for the SSB-less SCell such as time/frequency synchronization, L1/L3 measurements and SCell activation based on the associated SCell.

One scenario that Rel-18 SSB-less SCell does not cover is when only one FR2 SCell is configured to the UE. Then, since the FR2 SCell does not have associated SCell (having similar radio characteristics and similar geographical condition), FR2 SCell is forced to transmit SSB continuously.

To overcome such restriction, it is necessary to define a new set of operations between the UE and GNBs that enables dynamic turning on>off SSB transmissions.

In the new set of operations, GNB may switch the type/status/state of an SCell.

Table 1 below explains three states of the SCell.

TABLE 1

| | | Deactivated SCell with | Deactivated SCell |
|---|---|---|---|
| | | SSB transmission (D1- | without SSB |
| | Active SCell (A-SCell) | SCell) | transmission (D2-SCell) |
| Characteristics | most power | less power | least power |
| | consuming; and | consuming than A-SCell; | consuming; and |
| | shortest latency | and | longest latency |
| | for data | longer latency | for data |
| | transmission > reception. | for data | transmission > reception |
| | | transmission > reception | (SCell activation and |
| | | (SCell activation is | SSB transmission |
| | | required before data | activation are required |
| | | transmission > reception). | before data |
| | | | transmission > reception). |
| PDCCH | UE monitors PDCCH | UE does not monitor | UE does not monitor |
| | | PDCCH | PDCCH |
| PUSCH/PUCCH/SRS | UE transmit | UE does not transmit | UE does not transmit |
| | PUSCH/PUCCH/SRS | PUSCH/PUCCH/SRS | PUSCH/PUCCH/SRS |
| CSI reporting | UE report CSI | UE does not report CSI | UE does not report CSI |
| CSI measurement | UE measure CSI | UE does not measure | UE does not measure |
| | | CSI | CSI |
| SSB measurement | UE measure SSB with a | UE measures SSB with a | UE does not measure |
| | periodicity determined | periodicity determined | SSB |
| | based on DRX cycle | based on DRX cycle and | |
| | | measCycleSCell | |
| Beam Management | UE performs BM based | UE does not perform BM | UE does not perform BM |
| | on CSI | | |
| L3 RRM | Serving cell | Serving cell | No serving cell |
| measurement | measurement for A1 and | measurement for A1 and | measurement for A1 and |
| | A2 | A2 | A2 |
| | Applicable cell | Applicable cell | Not applicable |
| | for A3 and A5 | for A3 and A5 | cell for A3 and A5 |
| | Measurement results | Measurement results | Measurement results |
| | reported in | reported in | reported in |
| | MeasurementReport | MeasurementReport | MeasurementReport |

Based on traffic load and channel condition of a UE, GNB determines which state to be applied and performs necessary procedure for state transition. The transition is performed between the adjacent states/types (i.e. from A-SCell to D1-SCell or vice versa; from D1-SCell to D2-SCell or vice versa). Transition between A-SCell and D1-SCell is performed based on SCell Activation/Deactivation MAC CE. Transition between D1-SCell and D2-SCell is performed based on DCI 2_10. Transition from D2-SCell to A-SCell can be performed based on SCell Activation>Deactivation MAC CE (if a SCell is activated by the SCell Activation/Deactivation MAC CE and if the SCell is D2-SCell, transition from D2-SCell to A-SCell occurs; UE determines that SSB transmission of the serving cell will start at slot n+m3).

DCI 2_10 causes one or more UEs to change the status of a SCell. SCell A/D MAC CE causes a single UE to change the status of a SCell.

Table 2 summarizes state transitions.

TABLE 2

| State transition | State transition caused | |
|---|---|---|
| direction | by | State transition delay |
| A-SCell → D1-SCell | Reception of A/D MAC CE | When MAC CE is received in slot n, UE start |
| | (the corresponding Ci bit is set | operations related to D1-SCell at slot n + k. |
| | to 0 and the SCell was | # k = m + 3# x + 1. |
| | activated prior to receiving the | # slot n + m is a slot where HARQ-ACK for |
| | A/D MAC CE); or | the MAC CE is indicated. |
| | Expiry of | # x is number of slots per subframe for the |
| | sCellDeactivation Timer | SCS configuration of the PUCCH |
| | associated with SCell | transmission. |
| D1-SCell → A-SCell | Reception of A/D MAC CE | When MAC CE is received in slot n, UE start |
| | (the corresponding Ci bit is set | operations related to A-SCell at slot n + k. |
| | to 1 and the SCell was | # k = m + 3# x + 1. |
| | deactivated prior to receiving | # slot n + m is a slot where HARQ-ACK for |
| | the A/D MAC CE) | the MAC CE is indicated. |
| | | # x is number of slots per subframe for the |
| | | SCS configuration of the PUCCH |
| | | transmission. |
| D1-SCell → D2-SCell | Reception of DCI 2_10 (A | When DCI 2_10 is received in slot n of |
| | specific bit in block whose | serving cell a, UE starts operations related to |
| | block number corresponds to | D2-SCell at slot n + h of serving cell b. |
| | the SCell is set to 0 and the | # h = c + y; |
| | SCell was D1-SCell prior to | # c is a parameter having a different value |
| | receiving DCI 2_10) | depending on a specific SCS. If the specific |
| | | SCS is 15 KHz, a is 1. If 30 KHz, a is 2. If 60 |
| | | KHz, a is 3. |
| | | # The specific SCS is the smallest one among: |
| | | ## SCS of a specific DL BWP of the serving |
| | | cell b; and |
| | | ## SCS of a specific DL BWP of the serving |
| | | cell a. |
| | | ## Serving cell a is the serving cell where |
| | | DCI 2_10 is received. |
| | | # Serving cell b is the serving cell of which |
| | | status changes based on the received DCI |
| | | 2_10 (e.g. the concerned SCell) is to occur. |
| | | # The specific DL BWP of the serving cell b |
| | | is the BWP indicated by |
| | | firstActiveDownlinkBWP-Id of the serving |
| | | cell b or is initialDownlinkBWP of the |
| | | serving cell b. |
| | | # The specific DL BWP of the serving cell a |
| | | is the BWP where DCI 2_10 is received (or |
| | | DCI 2_10 is configured). |
| | | # y is: |
| | | ## 0 if SCS of the specific DL BWP of the |
| | | serving cell where DCI 2_10 is received and |
| | | SCS of the specific DL BWP of the SCell are |
| | | same; |
| | | ## otherwise, 1. |
| D2-SCell → D1-SCell | Reception of DCI 2_10 (A | When DCI 2_10 is received in slot n of |
| | specific bit in block whose | serving cell a, UE starts operations related to |
| | block number corresponds to | D1-SCell at slot n + h of serving cell b. |
| | the SCell is set to 1 and the | # h = c + y; |
| | SCell was D1-SCell prior to | # c is a parameter having a different value |
| | receiving DCI 2_10) | depending on a specific SCS. If the specific |
| | | SCS is 15 KHz, a is 1. If 30 KHz, a is 2. If 60 |
| | | KHz, a is 3. |
| | | # The specific SCS is the smallest one among: |
| | | ## SCS of a specific DL BWP of the serving |
| | | cell b; and |
| | | ## SCS of a specific DL BWP of the serving |
| | | cell a. |
| | | ## Serving cell a is the serving cell where |
| | | DCI 2_10 is received. |
| | | # Serving cell b is the serving cell of which |
| | | status changes based on the received DCI |
| | | 2_10 (e.g. the concerned SCell) is to occur. |
| | | # The specific DL BWP of the serving cell b |
| | | is the BWP indicated by |
| | | firstActiveDownlinkBWP-Id of the serving |
| | | cell b or is initialDownlinkBWP of the |
| | | serving cell b. |
| | | # The specific DL BWP of the serving cell a |
| | | is the BWP where DCI 2_10 is received (or |
| | | DCI 2_10 is configured). |
| | | # y is: |
| | | ## 0 if SCS of the specific DL BWP of the |
| | | serving cell where DCI 2_10 is received and |
| | | SCS of the specific DL BWP of the SCell are |
| | | same; |
| | | ## otherwise, 1. |
| D2-SCell → A-SCell | Reception of A/D MAC CE | When MAC CE is received in slot n, UE start |
| | (the corresponding Ci bit is set | operations related to D1-SCell at slot n + k. |
| | to 1 and the SCell was D2- | # k = m + q # x + 1 |
| | SCell prior to receiving the | # slot n + m is a slot where HARQ-ACK for |
| | A/D MAC CE) | the MAC CE is indicated. |
| | | # x is number of slots per subframe for the |
| | | SCS configuration of the PUCCH |
| | | transmission. |
| | | # q is an integer greater than 3. q is fixed in |
| | | the specification and stored in ROM of the UE. |
| A-SCell → D2-SCell | Reception of DCI 2_10 (A | When DCI 2_10 is received in slot n of |
| | specific bit in block whose | serving cell a, UE starts operations related to |
| | block number corresponds to | D2-SCell at slot n + h of serving cell b. |
| | the SCell is set to 0 and the | # h = c + y; |
| | SCell was A-SCell prior to | # c is a parameter having a different value |
| | receiving DCI 2_10) | depending on a specific SCS. If the specific |
| | | SCS is 15 KHz, a is 1. If 30 KHz, a is 2. If 60 |
| | | KHz, a is 3. |
| | | # The specific SCS is the smallest one among: |
| | | ## SCS of a specific DL BWP of the serving |
| | | cell b; and |
| | | ## SCS of a specific DL BWP of the serving |
| | | cell a. |
| | | ## Serving cell a is the serving cell where |
| | | DCI 2_10 is received. |
| | | # Serving cell b is the serving cell of which |
| | | status changes based on the received DCI |
| | | 2_10 (e.g. the concerned SCell) is to occur. |
| | | # The specific DL BWP of the serving cell b |
| | | is the BWP indicated by |
| | | firstActiveDownlinkBWP-Id of the serving |
| | | cell b or is initialDownlinkBWP of the |
| | | serving cell b. |
| | | # The specific DL BWP of the serving cell a |
| | | is the BWP where DCI 2_10 is received (or |
| | | DCI 2_10 is configured). |
| | | # y is: |
| | | ## 0 if SCS of the specific DL BWP of the |
| | | serving cell where DCI 2_10 is received and |
| | | SCS of the specific DL BWP of the SCell are |
| | | same; |
| | | ## otherwise, 1. |

At 610 UE receives from the GNB a RRCReconfiguration message. The RRCReconfiguration message comprises following fields/IEs.
#measConfig field that comprises MeasConfig IE
#spCellConfig field that comprises SpCellConfig IE
   ##newUE-Identity field that comprises RNTI-Value IE (for C-RNTI);
#sCellToAddModList field that comprises one or more SCellConfig IEs; Each of SCellConfig may comprises:
   ##SSB_OFF_INDICATION field that indicates whether the SSB is transmitted in the corresponding SCell;
   ##positionInDCI_SSB_indication field that indicates the starting position of an information block of DCI format 2_10 (e.g., SSB_State_Indication) for this serving cell;
   ##valid_measurement_window field that indicates the time duration related to validity of the measurements taken for SCells that have been changed to D2-SCell recently.
#SSB_State_Indication configuration IE;
   ##cell_SSB_RNTI field that comprises RNTI for SSB_State_Indication;
   ##sizeDCI-2-10 field that indicates the size of SSB_State_Indication.

UE configures one or more SCells based on ServingCellConfigCommon IE and ServingCellConfig IE in SCellConifg. UE associates each SCell with a serving cell index. The serving cell index is derived from (or is equal to) SCellIndex IE. UE performs SCell state determination

At 620, UE performs SCell state determination.
#For each SCell, UE determines state of each SCells:
   ##sCellState field is present in the SCellConfig IE, the corresponding SCell is in activated state (A-SCell);
   ##sCellState field is absent and SSB_OFF_INDICATION field is absent, the corresponding SCell is deactivated state with SSB transmission (D1-SCell);
   ##sCellState field is absent and SSB_OFF_INDICATION field is present, the corresponding SCell is deactivated state without SSB transmission (D2-SCell).

UE associates each SCell with a MeasObject based on servingCellMO field in the corresponding ServingCellConfig IE. UE configures measurements based on MeasConfig IE.

After performing configurations based on the RRCReconfiguration, UE transmits to the GNB a RRCReconfigurationComplete.

At 630, UE performs measurement related operations. UE may perform serving_cell_measurement_operation for each serving cell. UE determines, through the operation, which to measure and which to not measure.

<serving_cell_measurement_operation>
#for each serving cell for which servingCellMO is configured, UE performs followings:
##if the serving cell is PCell or A-SCell or D1-SCell;
###UE measure SS/PBCH blocks of the serving cell based on SSB-ToMeasure in the MeasObjectNR IE indicated by corresponding servingCellMO (or based on SSB-ToMeasure in the ServingCellConfigCommon); and
###UE derive layer 3 filtered RSRP and RSRQ per beam for the serving cell based on SS/PBCH block;
##if the serving cell is D2-SCell;
###UE does not measure SS/PBCH blocks of the serving cell;
###UE does not derive layer 3 filtered RSRP and RSRQ per beam for the serving cell.

UE performs evaluation on measurement report triggering. UE may perform, following in the order:
#applicable_cell_determination to determine applicable cells and neighbouring cells;
#determining_whether_to_perform_measurement_reporting_triggering_evaluation;
#measurement_report_triggering_evaluation;
#measurement_report_initiating_on_entering or measurement_report_initiating_on_leaving or both; and
#cellTriggeredList_update.
UE performs following for applicable_cell_determination.
#For first type event,
##For a measId that is configured with a first type event (alternatively, for each measId, for which the first type event is configured in the corresponding reportConfig):
###UE considers only the serving cell to be applicable for the first type event (alternatively, UE consider a specific SCell to be applicable for the event; the specific SCell is the SCell that is associated with a specific measObject; the specific measObject is associated with a specific reportConfig; the specific reportConfig configures the first type event).
#For second type event,
##For a measId that is configured with a second type event (alternatively, for each measId, for which the second type event is configured in the corresponding reportConfig):
###if the concerned measObjectNR (the measObjectNR associated with the measId) is associated with a SCell; and
###if the SCell associated with the measObjectNR is A-SCell or D1-SCell;
####UE considers the SCell to be a neighbouring cell;
#####if useAllowedCellList is set to true and if the SCell is included in the allowedCellsToAddModList,
######UE considers the SCell to be applicable.
#####if useAllowedCellList is set to true and if the SCell is not included in the allowedCellsToAddModList,
######UE considers the SCell to be not applicable.
#####if useAllowedCellList is set to false and if the SCell is not included in the excludedCellsToAddModList,
######UE considers the SCell to be applicable.
#####if useAllowedCellList is set to false and if the SCell is included in the excludedCellsToAddModList,
######UE considers the SCell to be not applicable.
###if the SCell associated with the measObjectNR is D2-SCell,
###UE considers the SCell neither neighbouring cell nor to be applicable.
#For third type event,
##For a measId that is configured with a third type event (alternatively, for each measId, for which the third type event is configured in the corresponding reportConfig):
###if the concerned measObjectNR (the measObjectNR associated with the measId) is associated with a SCell,
####UE considers the SCell neither neighbouring cell nor to be applicable.
UE performs followings for determining_measurement_report_triggering_evaluation.
   <determining_whether_to_perform_measurement_report_triggering_evaluation>
#For first type event,
##For a measId that is configured with a first type event (alternatively, for each measId, for which the first type event is configured in the corresponding reportConfig):
###if the applicable cell for the first type event is A-SCell or D1-SCell,
####UE determines to perform measurement_reporting_triggering_evaluation for the measId;
###if the applicable cell for the first type event is D2-SCell,
####UE determines to not perform measurement_report_triggering_evaluation for the measId (and determines to perform neither measurement_report_initiating_on_entering nor measurement_report_initiating_on_leaving);
####UE determines to perform measurement_report_triggering_evaluation for the measId when a specific DCI 2_10 is received.
#For second type event and third type event,
##For a measId that is configured with a second type event or a third type event:
###UE determines to perform measurement_report_triggering_evaluation for the measId.

UE determines types of events as follows.
#First type event is an event that is related only to a specific serving cell.
##The specific serving cell is PCell or SCell that is associated with the corresponding ReportConfig (i.e. ARFCN of the serving cell is same as ARFCN of MeasObjectNR associated with the ReportConfiig#MeasId).
##Only the specific serving cell is applicable.
##Event A1 and Event A2 are first type event.
#Second type event is an event that is related to a specific serving cell and one or more neighbouring cells.
##The specific serving cell is PCell.
##The one or more neighbouring cells comprises:
###neighbouring cells detected based on parameters in the associated measObjectNR; and
###SCell associated with the corresponding ReportConfig (i.e. ARFCN of the serving cell is same as ARFCN of MeasObjectNR associated with the ReportConfiig#MeasId).
##Some of the one or more neighbouring cells are applicable.
##Event A3 and Event A5 are second type event.
#Third type event is an event that is related to only neighbouring cells.
##The one or more neighbouring cells are neighbouring cells detected based on parameters in the associated measObjectNR.

##Some of the one or more neighbouring cells are applicable.

##Event A4 is third type event

UE performs followings for measurement_report_triggering_evaluation.

<measurement_report_triggering_evaluation>
#For measurement_report_triggering_evaluation for an event (or for a measId associated with the event);
##UE determines to trigger measurement_report_initiating_on_entering if the following conditions are fulfilled.
###the entry condition applicable for this event is fulfilled for one or more applicable cells for all measurements after layer 3 filtering taken during timeToTrigger defined for this event; and
###at least one of the one or more applicable cells is not included in the cellsTriggeredList.
##UE determines to trigger measurement_report_initiating_on_leaving if the following conditions are fulfilled.
###the leaving condition applicable for this event is fulfilled for one or more applicable cells for all measurements after layer 3 filtering taken during timeToTrigger defined for this event; and
###at least one of the one or more applicable cells is included in the cellsTriggeredList.
   <measurement_report_initiating_on_entering>

For measurement_report_initiating_on_entering for a measId, UE may:
#include the measurement reporting entry within the VarMeasReportList for this measId, if not included yet;
#include the concerned cell(s) in the cellsTriggeredList defined within the VarMeasReportList for this measId (the concerned cell is the cell that triggered the measurement_report_initiating_on_entering);
#if useT312 is set to true in reportConfig for this event:
##if T310 for the corresponding SpCell is running; and
##if T312 is not running for corresponding SpCell:
###start timer T312 for the corresponding SpCell with the value of T312 configured in the corresponding measObjectNR;
#initiate the measurement reporting procedure.
   <measurement_report_initiating_on_leaving>

For measurement_report_initiating_on_leaving for a measId, UE may:

#remove the concerned cell(s) in the cellsTriggeredList defined within the VarMeasReportList for this measId (the concerned cell is the cell that triggered the measurement_report_initiating_on_leaving);
#if reportOnLeave is set to true for the corresponding reporting configuration
##initiate the measurement reporting procedure, as specified in 5.5.5;
#if the cellsTriggeredList defined within the VarMeasReportList for this measId is empty:
##remove the measurement reporting entry within the VarMeasReportList for this measId;

UE performs followings for cellsTriggeredList_update.

For cellsTriggeredList_update for a measId, UE may:
#if the entry condition applicable for the event associated with the measId is fulfilled for one or more cells for all measurements after layer3 filtering taken during timeToTriggered; and
#if the one or more cells are not included in cellTriggeredList:
##include the one or more cells in the cellsTriggeredList for the MeasId; and
##initiate the measurement reporting procedure;
#if the leaving condition applicable for the event associated with the measId is fulfilled for one or more of the cells for all measurements after layer3 filtering taken during timeToTriggered; and
#if the one or more cells are included in cellTriggeredList:
##remove the one or more cells in the cellsTriggeredList for the MeasId; and
##initiate the measurement reporting procedure.

UE may remove a specific cell from cellTriggeredList in case that the cell state changes from A-SCell or D1-SCell to D2-SCell (due to reception of SSB_State_Indication). In this case, UE does not initiate the measurement reporting procedure for the MeasId even when the associated ReportConfig is configured with reportOnLeave.

At 640, UE performs measurement report procedure related operations as follows. UE triggers measurement report procedure based on the measurement related operations (e.g. based on determination whether to trigger measurement reporting procedure). Based on the determination, UE performs measurement reporting procedure. For measurement reporting procedure, UE may perform measurement_result_inclusion.

UE performs followings for measurement_result_inclusion through which UE may determine which serving cell's measurement result shall be included in the measurement report message.

<measurement_result_inclusion>
#for each serving cell configured with servingCellMO,
##if the serving cell is PCell or A-SCell or D1-SCell,
###include the MeasResultServMO IE of the serving cell in the MeasResultServMOList IE;
##if the serving cell is D2-SCell, and if L3 filtered measurement results for D2-SCell determined within the valid_measurement_window is available (i.e. D2-SCell was D1-SCell at least valid_measurement_window before),
###include the corresponding MeasResultServMO IE in the MeasResultServMOList IE,
##if the serving cell is D2-SCell, and if L3 filtered measurement results for D2-SCell determined within valid_measurement_window is not available;
###not include the corresponding MeasResultServMO IE in the MeasResultServMOList IE.

Alternatively,
#for each serving cell configured with servingCellMO,
##if the serving cell is PCell or A-SCell or D1-SCell,
###include the type1_MeasResultServMO IE of the serving cell in the MeasResultServMOList IE;
##if the serving cell is D2-SCell, and if L3 filtered measurement results for D2-SCell determined within valid_measurement_window is available (i.e. D2-SCell was D1-SCell at least valid_measurement_window before),
###include the type1_MeasResultServMO IE in the MeasResultServMOList IE,
##if the serving cell is D2-SCell, and if L3 filtered measurement results for D2-SCell determined within valid_measurement_window is not available;
###include the type2_MeasResultServMO IE in the MeasResultServMOList IE.

type1_MeasResultServMO IE comprises followings:
#servCellId field that comprises ServCellIndex;
#measResultServingCell field that comprises:
##physCellId field that comprises PhysCellId of the serving cell;
##resultsSSB-Cell field or resultsCSI-RS-Cell field that comprises RSRP#RSRQ of the serving cell;
##rsIndexResults field that comprises beam level measurement results of the serving cell;
#measResultBestNeighCell field that comprises:
##physCellId field that comprises PhysCellId of the best neighboring cell;
##resultsSSB-Cell field or resultsCSI-RS-Cell field that comprises RSRP#RSRQ of the best neighboring cell;
##rsIndexResults field that comprises beam level measurement results of the best neighboring cell.

type2_MeasResultServMO IE comprises followings:
#servCellId field that comprises ServCellIndex;
##measResultServingCell field that comprises:
###physCellId field that comprises PhysCellId of the serving cell;
##measResultBestNeighCell field that comprises:
###physCellId field that comprises PhysCellId of the best neighboring cell;
###resultsSSB-Cell field or resultsCSI-RS-Cell field that comprises RSRP#RSRQ of the best neighboring cell;
###rsIndexResults field that comprises beam level measurement results of the best neighboring cell.

At 650, UE transmits to GNB a MeasurementReport. The MeasurementReport comprises a MeasResultServMOList. GNB may determine to change the states of one or more SCells based on the measurement report. GNB may transmit SSB_State_Indication to change the state of the one or more SCells.

UE performs PDCCH_monitoring_for_detecting SCell_status_change.

UE performs followings for PDCCH_monitoring_for_detecting SCell_status_change.

### <PDCCH_monitoring_for_detecting SCell_status_change>

#For SSB_State_Indication reception, UE monitors SSB_State_Indication_CSS in one or more specific serving cells based on SSB_State_Indication_RNTI;
##configuration parameters for SSB_State_Indication_CSS is comprised in the SpCellConfig IE;
##the one or more specific serving cells may be:
###a PCell; and
###one or more SCells that is activated and of which active BWP is configured with the SSB_State_Indication_CSS;
#For SCell A/D MAC CE reception, UE monitors USS based on C-RNTI in all serving cells that is currently activated;
##configuration parameters for USS is comprised in the SCellConfig IE and in SpCellConfig IE.

At 670, UE receives from GNB SSB_State_Indication. The SSB_State_Indication is carried in DCI format 2_10 or in a MAC CE. SSB_State_Indication indicates, for each cell:
#SSB transmission will stop in a specific time point;
#SSB transmission will start in a specific time point;
#SSB transmission will continue; or
#No SSB transmission will continue.

### <DCI Format 2_10>

DCI format 2_10 is used for activating or de-activating the SSB transmission of one or multiple SCells for one or more UEs.

The following information is transmitted by means of the DCI format 2_10 with CRC scrambled by cell_SSB_RNTI:
#block number 1, block number 2, . . . , block number N
##the starting position of a block associated with a serving cell is determined by the parameter positionInDCI_SSB_indication provided by higher layers (in a RRCReconfiguration) for the UE.

If the UE is configured to monitor DCI 2_10 with CRC scrambled by cell_SSB_RNTI, one or more blocks are configured for the UE by higher layers (in a RRCReconfiguration), with the following fields defined for each block:
#SSB indication-number of bits determined by the following:
##If higher layer parameter positionInDCI_SSB_indication is configured
###1 bit; 0 indicates that SSB transmission is deactivated (no SSB transmission in the corresponding cell); 1 indicates that SSB transmission is activated (SSB is transmitted in the corresponding cell)
###0 bit otherwise.
#SSB time offset-number of bits determined by the following:
##If higher layer parameter time_offset_InDCI_SSB_indication is configured
###5 bit; 0 indicates that SSB transmission is activated or deactivated in a predefined time point; 1 indicates that SSB transmission is activated or deactivated in the first SSB transmission occasion after slot n (or symbol n); . . . ; 31 indicates that SSB transmission is activated or deactivated in the 31-th SSB transmission occasion after symbol n; slot n (or symbol n) is the slot (symbol) that the DCI 2_10 is received. The SSB transmission occasion is determined from SSB-ToMeasure in the ServingCellConfigCommon of the SCell. ###0 bit otherwise.

The size of DCI format 2_10 is indicated by the higher layer parameter sizeDCI-2-10.

A block in DCI 2_10 is either a 6 bit or a single bit or a zero bit. Each block is associated with a SCell. The association between the block and the SCell (serving cell) is indicated by the parameter positionInDCI_SSB_indication field in the serving cell for configuration information for the SCell. The highest possible value positionInDCI_SSB_indication is first integer.

A Ci bit in SCell A/D MAC CE is a single bit. Each Ci bit is associated with a SCell. The association between the Ci and the SCell is derived from SCell index. The highest possible value for SCell index is second integer.

The first integer is greater than the second integer because the first integer is related with serving cells of plurality of terminals while the second integer is related with serving cells of a single terminal.

At 680, UE performs, based on DCI 2_10, SCell_status_change_determination. UE determines, for a SCell, whether the SSB transmission in the SCell is activated or deactivated based on received DCI 2_10.

At 690, UE performs, considering the changed status, measurement related operations.
#UE may perform serving_cell_measurement_operation_adjusted for each SCell.
#UE performs evaluation on measurement report triggering.
##UE performs applicable_cell_determination_after_SCell_status_change to determine applicable cells and neighbouring cells.
##UE performs determining_whether_to_perform_measurement_reporting_triggering_evaluation_after_SCell_status_change for measId configured with the first type event.
##UE performs measurement_report_triggering_evaluation.
##UE performs measurement_report_triggering_evaluation.
##UE may perform measurement_report_initiating_on_entering or measurement_report_initiating_on_leaving or both.
##UE may perform cellTriggeredList_update.

At 6100, UE performs measurement related operations based on the adjustment.

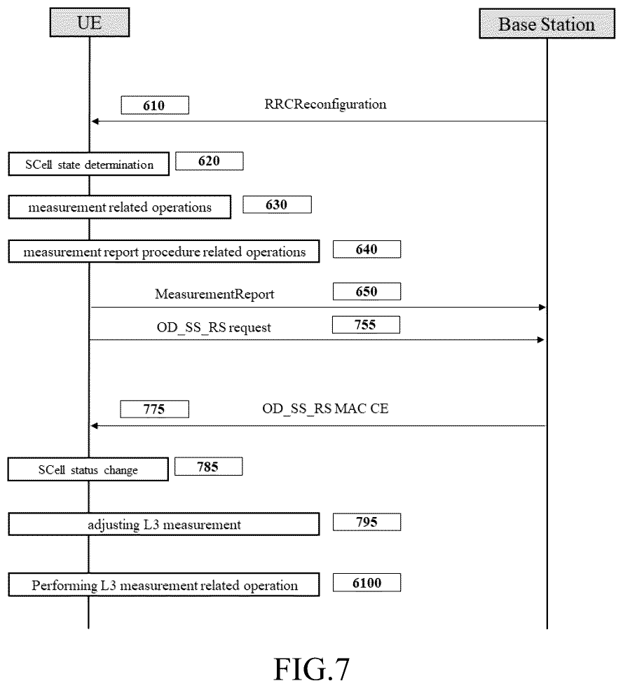

FIG. 7 illustrates operations of UE and base station for on-demand SSB.

Followings may be used interchangeably:
OD-SS-RS and SS/RS;
SS/RS and SS-RS and SS and SSB (e.g. the procedure/message/operation for SS/RS are also applicable when SSB is used instead of SS/RS) and specific signal block;
sparse SS-RS and normal SS-RS and periodic SS-RS and always-on SS-RS;
enabled and activated;
OD-SSB activation/deactivation information and DCI 2_10 and OD_SS_RS MAC CE
   <SS-RS burst>

A set of specific signal blocks (SS-RS burst) is transmitted in a SCell during a half frame. For periodic SS-RS, the half frame occurs periodically with periodicity indicated by ssb-periodicityServingCell once it is configured. For OD-SS-RS, the half frame occurs periodically with periodicity indicated by ssb-periodicityServingCell2 once it is enabled.

For a half frame with specific signal blocks, the first symbol indexes for candidate specific signal blocks are determined according to the SCS of specific signal blocks as follows, where index 0 corresponds to the first symbol of the first slot in a half-frame.
#Case A—15 kHz SCS: the first symbols of the candidate specific signal blocks have indexes of {2,8}+14·n
##For operation without shared spectrum channel access:
###For carrier frequencies smaller than or equal to 3 GHz, n=0, 1.
###For carrier frequencies within FR1 larger than 3 GHz, n=0, 1, 2, 3.
##For operation with shared spectrum channel access, as described in [15, TS 37.213], n=0, 1, 2, 3, 4.
#Case B—30 kHz SCS: the first symbols of the candidate specific signal blocks have indexes {4,8,16,20}+28.n. For carrier frequencies smaller than or equal to 3 GHZ, n=0. For carrier frequencies within FR1 larger than 3 GHz, n=0, 1.
#Case C—30 kHz SCS: the first symbols of the candidate specific signal blocks have indexes {2,8}+14·n.
##For operation without shared spectrum channel access
###For paired spectrum operation
####For carrier frequencies smaller than or equal to 3 GHZ, n=0, 1. For carrier frequencies within FR1 larger than 3 GHZ, n=0, 1, 2, 3.
###For unpaired spectrum operation
####For carrier frequencies smaller than 1.88 GHz, n=0, 1. For carrier frequencies within FR1 equal to or larger than 1.88 GHz, n=0, 1, 2, 3.
##For operation with shared spectrum channel access, n=0, 1, 2, 3, 4, 5, 6, 7, 8, 9.
#Case D—120 kHz SCS: the first symbols of the candidate specific signal blocks have indexes {4,8,16,20}+28.n. For carrier frequencies within FR2 and FR2-NTN, n=0,1, 2, 3, 5, 6, 7, 8, 10, 11, 12, 13, 15, 16, 17, 18.
#Case E—240 kHz SCS: the first symbols of the candidate specific signal blocks have indexes {8,12,16,20,32,36,40,44}+56·n. For carrier frequencies within FR2-1 and FR2-NTN, n=0, 1, 2, 3, 5, 6, 7, 8.
#Case F—480 kHz SCS: the first symbols of the candidate specific signal blocks have indexes {2,9}+14.n. For carrier frequencies within FR2-2, n=0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31.
#Case G—960 kHz SCS: the first symbols of the candidate specific signal blocks have indexes {2,9}+14.n. For carrier frequencies within FR2-2, n=0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31.

The candidate specific signal blocks in a half frame are indexed in an ascending order in time from 0 to ⁻L_max−1, where ⁻L_max is determined according to SS/PBCH block patterns for Cases A through G. L_max is a maximum number of SS/PBCH block indexes in a cell, and the maximum number of transmitted specific signal blocks within a half frame is L_max.
#For operation without shared spectrum channel access in FR1 and FR2, and for operation with shared spectrum channel access in FR2-2, L_max=⁻L_max
#For operation with shared spectrum channel access in FR1, L_max=8 for ⁻L_max=10 and 15 kHz SCS of specific signal blocks and for ⁻L_max=20 and 30 kHz SCS of specific signal blocks

A UE can be provided per serving cell by ssb-periodicityServingCell a periodicity of the half frames for reception of the sparse specific signal blocks for the serving cell. If the UE is not configured a periodicity of the half frames for receptions of the sparse specific signal blocks, the UE assumes a periodicity of a half frame. A UE assumes that the periodicity is same for all specific signal blocks in the serving cell.

A UE can be provided per serving cell by ssb-periodicityServingCell2 a periodicity of the half frames for reception of the on demand specific signal blocks for the serving cell. If the UE is not configured a periodicity of the half frames for receptions of the on-demand specific signal blocks, the UE assumes the serving cell does not support on-demand specific signal block.

FIG. 7 illustrates operations of UE and base station for on-demand SSB.

At 610 UE receives from the GNB a RRCReconfiguration message. The message may comprise following IE.
#OD_SS_RS-RequestConfig that comprises configuration information for OD_SS_RS request per SCells; and
#sCellToAddModList field that comprises one or more SCellConfig IEs.

| | |
|---|---|
| SCellConfig ::= | SEQUENCE { |
| sCellIndex | SCellIndex, |
| sCellConfigCommon | ServingCellConfigCommon |

OPTIONAL, -- Cond SCellAdd

| | |
|---|---|
| sCellConfigDedicated | ServingCellConfig |

```
OPTIONAL, -- Cond SCellAddMod
    ..,
    [[
```

| | |
|---|---|
| smtc | SSB-MTC |

OPTIONAL -- Need S

| | |
|---|---|
| smtc2 | SSB-MTC |

```
OPTIONAL -- Need S
    ]],
    [[
```

| | |
|---|---|
| sCellState-r16 | ENUMERATED {activated} |

OPTIONAL, -- Cond SCellAddSync

| | |
|---|---|
| sCellState-r18 | ENUMERATED {SSB-OFF} |

OPTIONAL,

| | |
|---|---|
| sCellStateUponDeactivation-r18 | ENUMERATED {SSB-OFF} |

OPTIONAL,

| | |
|---|---|
| secondaryDRX-GroupConfig-r16 | ENUMERATED {true} |

```
OPTIONAL -- Need S
    ]],
    [[
```

| | |
|---|---|
| preConfGapStatus-r17 | BIT STRING (SIZE (maxNrofGapId- |
| r17)) | OPTIONAL, -- Cond PreConfigMG |
| goodServingCellEvaluationBFD-r17 | GoodServingCellEvaluation-r17 |

OPTIONAL, -- Need R

| | |
|---|---|
| sCellSIB20-r17 | SetupRelease { SCellSIB20-r17 } |

```
OPTIONAL -- Need M
    ]],
    [[
```

| | |
|---|---|
| plmn-IdentityInfoList-r17 | SetupRelease {PLMN-IdentityInfoList} |

OPTIONAL, -- Cond SCellSIB20-Opt

| | |
|---|---|
| npn-IdentityInfoList-r17 | SetupRelease {NPN-IdentityInfoList-r16} |

```
OPTIONAL -- Cond SCellSIB20-Opt
    ]]
  }
```

SCellState-r16 field indicates whether the SCell shall be considered to be in activated state upon SCell configuration. If this field is absent, the SCell shall be considered to be in deactivated state upon SCell configuration.

SCellState-r18 field indicates whether SSB transmission is disabled in the SCell when SCell configuration is received. If this field is absent, the SSB shall be considered being transmitted in the SCell when SCell configuration is received.

TABLE 3

| SCellState- | SCellState- | |
|---|---|---|
| r16 | r18 | Description |
| Present | Present | Not valid; UE ignore SCellConfig. |
| Present | Absent | The SCell is activated (e.g. A-SCell). |
| Absent | Present | The SCell is deactivated; SSB transmission |
| | | is disabled (e.g. D2-SCell). |
| Absent | Absent | The SCell is deactivated; SSB transmission |
| | | is enabled (e.g. D1-SCell). |

SCellStateUponDeactivation-r18 field indicates whether SSB transmission is disabled in the SCell when SCell is deactivated after being activated (e.g. due to expiry of SCell. If this field is absent, the SSB shall be considered being transmitted in the SCell when SCell configuration is received.

In CASE #1 (only OD-SS-RS), smtc field indicates the OD-SS-RS periodicity/offset/duration configuration of the SCell. If the field is absent and absoluteFrequencySSB is included, the UE uses the SMTC in the measObjectNR having the same SSB frequency and subcarrier spacing, as configured before the reception of the RRC message. In case that the SCell is either A-SCell or D1-SCell, SMTC is valid upon SCell configuration. In case that the SCell is D2-SCell, SMTC is invalid upon SCell configuration until SSB transmission is enabled. SMTC is valid upon receiving a MAC CE that enables OD-SS-RS transmission.

In CASE #2 (OD-SS-RS+sparse SS-RS), smtc field comprises parameter for the sparse SS-RS (SS-RSs that are periodically transmitted) and smtc2 field comprises parameter for the OD-SS-RS. smtc is valid when it is configured, smtc2 is valid when it is configured and OD-SS-RS transmission is enabled for the SCell.

| SSB-MTC ::= | SEQUENCE { |
|---|---|
| periodicityAndOffset | CHOICE { |
| sf5 | INTEGER (0..4), |
| sf10 | INTEGER (0..9), |
| sf20 | INTEGER (0..19), |
| sf40 | INTEGER (0..39), |
| sf80 | INTEGER (0..79), |
| sf160 | INTEGER (0..159) |
| }, | |
| duration | ENUMERATED { sf1, sf2, |

sf3, sf4, sf5 }
}

Duration field indicates duration of the measurement window in which to receive SS/PBCH blocks. It is given in number of subframes.

periodicityAndOffset field indicates periodicity and offset of the measurement window in which to receive SS/PBCH blocks. Periodicity and offset are given in number of subframes.

| | |
|---|---|
| ServingCellConfigCommon ::= | SEQUENCE { |
| physCellId | PhysCellId |

OPTIONAL, -- Cond HOAndServCellAdd,

| | |
|---|---|
| downlinkConfigCommon | DownlinkConfigCommon |

OPTIONAL, -- Cond HOAndServCellAdd

| | |
|---|---|
| uplinkConfigCommon | UplinkConfigCommon |

OPTIONAL, -- Need M

| | |
|---|---|
| supplementaryUplinkConfig | UplinkConfigCommon |

OPTIONAL, -- Need S

| | |
|---|---|
| n-TimingAdvanceOffset | ENUMERATED { n0, n25600, |
| n39936 } | OPTIONAL, -- Need S |
| ssb-PositionsInBurst | CHOICE { |
| shortBitmap | BIT STRING (SIZE (4)), |
| mediumBitmap | BIT STRING (SIZE (8)), |
| longBitmap | BIT STRING (SIZE (64)) |

}
OPTIONAL, -- Cond AbsFreqSSB

| | |
|---|---|
| ssb-periodicityServingCell | ENUMERATED { ms5, ms10, ms20, |

ms40, ms80, ms160, spare2, spare1 } OPTIONAL, -- Need S

| | |
|---|---|
| ssb-periodicityServingCell2 | ENUMERATED { ms5, ms10, ms20, ms40, |

ms80, ms160, spare2, spare1 } OPTIONAL, -- Need S

| | |
|---|---|
| dmrs-TypeA-Position | ENUMERATED {pos2, pos3}, |
| lte-CRS-ToMatchAround | SetupRelease |
| { RateMatchPatternLTE-CRS } | OPTIONAL, -- Need M |
| rateMatchPatternToAddModList | SEQUENCE (SIZE |

(1..maxNrofRateMatchPatterns)) OF RateMatchPattern OPTIONAL, -- Need N

| | |
|---|---|
| rateMatchPatternToReleaseList | SEQUENCE (SIZE |

(1..maxNrofRateMatchPatterns)) OF RateMatchPatternId OPTIONAL, -- Need N

| | |
|---|---|
| ssbSubcarrierSpacing | SubcarrierSpacing |

OPTIONAL, -- Cond HOAndServCellWithSSB

| | |
|---|---|
| tdd-UL-DL-ConfigurationCommon | TDD-UL-DL-ConfigCommon |

OPTIONAL, -- Cond TDD

| | |
|---|---|
| ss-PBCH-BlockPower | INTEGER (−60..50), |
| ss-PBCH-BlockPower2 | INTEGER (−60..50), |

```
    SS_RS_Type
  ENUMERATED {SS, SS/RS}
    [[
```

Specific signal block is SS/PBCH block (PSS/SSS/PBCH DM-RS/PBCH) in case that the SCell is legacy SCell (e.g. SS_RS_Type is absent).

Specific signal block is PSS/SSS in case that the SCell is type1 SCell (e.g. SS_RS_Type is set to SS).

Specific signal block is PSS/SSS/PBCH DM-RS in case that the SCell is type 1 SCell (e.g. SS_RS_Type is set to SS/RS).

When specific signal block is SSB, following parameters are valid when they are configured.

downlinkConfigCommon indicates the common downlink configuration of the serving cell, including the frequency information configuration and the initial downlink BWP common configuration.

longBitmap is a bitmap when maximum number of specific signal blocks per half frame equals to 64.

mediumBitmap is a bitmap when maximum number of specific signal blocks per half frame equals to 8.

n-TimingAdvanceOffset indicates the N_TA-Offset to be applied for all uplink transmissions on this serving cell if n-TimingAdvanceOffset2 is not configured.

shortBitmap is a bitmap when maximum number of specific signal blocks per half frame equals to 4.

In type #1, ss-PBCH-BlockPower indicates average EPRE of the resources elements that carry secondary synchronization signals in dBm that the NW used for specific signal block transmission. It is used both for OD-SS-RS and sparse SS-RS.

In type #2, ss-PBCH-BlockPower2 indicates average EPRE of the resources elements that carry secondary synchronization signals in dBm that the NW used for OD-SS-RS transmission. It is used for OD-SS-RS only and valid when OD-SS-RS transmission is enabled for the SCell. ss-PBCH-BlockPower is valid for sparse OD-SS-RS only and valid when it is configured.

In type #1, ssb-periodicityServingCell indicates the OD-SS-RS periodicity in ms for the rate matching purpose. If the field is absent, the UE applies the value ms5. This field is used only when OD-SS-RS transmission is enabled.

ssb-PositionQCL indicates the QCL relation between specific signal block positions for this serving cell. It is used both for OD-SS-RS and sparse SS-RS.

ssb-PositionsInBurst indicates the time domain positions of the transmitted SS-blocks in a half frame with specific signal blocks. The first/leftmost bit corresponds to specific signal block index 0, the second bit corresponds to specific signal block index 1, and so on. Value 0 in the bitmap indicates that the corresponding specific signal block is not transmitted while value 1 indicates that the corresponding specific signal block is transmitted. It is used both for OD-SS-RS and sparse SS-RS.

ssbSubcarrierSpacing indicates Subcarrier spacing of specific signal block. It is used both for OD-SS-RS and sparse SS-RS.

tdd-UL-DL-ConfigurationCommon indicates a cell-specific TDD UL/DL configuration.

SS_RS_Type indicates whether SS-RS is PSS/SSS or PSS/SSS/PBCH DM-RS.

UE configures one or more SCells based on ServingCellConfigCommon IE and ServingCellConfig IE in SCellConifg. UE associates each SCell with a serving cell index. The serving cell index is derived from (or is equal to) SCellIndex IE. UE performs SCell state determination

At 620, UE performs SCell state determination. In addition, UE associates each SCell with a MeasObject based on servingCellMO field in the corresponding ServingCellConfig IE.

At 630, UE performs measurement related operations.

At 640, UE performs measurement report procedure related operations.

At 650, UE transmits to GNB a MeasurementReport.

At 755, UE may transmit OD_SS_RS request.

If UE determines D2-SCell needs to be activated, UE performs OD_SS_RS_REQUEST.

UE may perform, based on SIBI of the first cell, SI_REQEUST in a first cell to acquire/request OSI of the first cell.

UE may perform, based on SIB X of the first cell, MSI_REQUEST in a second cell to acquire/request SIBI of the second cell.

UE may perform, based on configuration information of the first cell, OD_SS_RS_REQUEST in the first cell to acquire/request SSB (excluding MIB) of the second cell.

First cell is a serving cell related to RRC connection establishment procedure. Second cell is a cell that is not the first cell.

At 775, GNB transmits to the UE a OD_SS_RS MAC CE to enable SSB transmission.

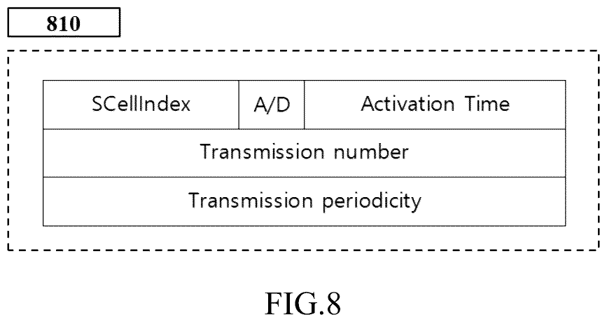

FIG. 8 illustrates the format of OD-SSB activation/deactivation MAC CE.

OD_SS_RS MAC CE (810) comprises following fields.
#SCellIndex field (3 bit): This field comprises an identifier that is derived from ServCellIndex of the SCell.
#A/D field (1 bit): This field indicates whether OD_SS_RS transmission is activated or deactivated.
#Activation Time field (4 bit): This field comprises 4 LSBs of SFN of the PCell where OD_SS_RS transmission in the SCell may start.
#Transmission number field (8 bit): This field indicates the number of OD_SS_RS burst transmission. Each OD_SS_RS burst comprises one or more OD_SS_RSs.
#Transmission periodicity field (8 bit): This field indicates the periodicity of OD_SS_RS burst transmission.

Activation Time field and Transmission number field and Transmission periodicity field are present in case that A/D field is set to 1 (indicating OD_SS_RS transmission is activated).

Activation Time field and Transmission number field and Transmission periodicity field are absent in case that A/D field is set to 0 (indicating OD_SS_RS transmission is deactivated).

At 785, UE performs, based on OD_SS_RS MAC CE, SCell_status_change_determination. UE determines, for a SCell, whether the OD_SS_RS transmission in the SCell is activated or deactivated based on received OD_SS_RS MAC CE. UE performs, for a SCell, beam_failure_operation if the A-SCell is deactivated to D2-SCell due to reception of received OD_SS_RS MAC CE.

<beam_failure_operation>

If a OD_SS_RS MAC CE is received at slot n of a first cell (one of one or more specific serving cells) and the OD_SS_RS MAC CE contains information that cause A-SCell to transition to D2-SCell, UE performs beam_failure_operation:

UE may, for the SCell:
#set BFI_COUNTER of each BFD-RS set of SCell to 0;
#consider the Beam Failure Recovery procedure successfully completed and cancel all the triggered BFRs of all BFD-RS sets of the Serving Cell.

When a OD_SS_RS MAC CE is received at slot n of the first cell, UE performs:
#beam_failure_operation for the second cell at a first point of time;
##the first point of time is n+number of slots per subframes of a specific BWP of the second cell; the specific BWP is firstActiveUplinkBWP or initialUplinkBWP;
#CSI reporting on the serving cell at a second point of time;
##the second point of time is n+3*number of slots per subframe of a specific BWP of a third cell; the third cell is the cell where CSI on PUCCH is transmitted; the specific BWP is UL BWP where CSI on PUCCH is transmitted.
#The first point of time is earlier than the second point of time.

When a SCell is deactivated, UE stops actions related to CSI reporting on a serving cell (e.g. PCell or PUCCH SCell):
#at n+k if SCell deactivation is caused by SCell A/D MAC CE (e.g. deactivation command in a PDSCH);
##k is m+3*number of slots per subframe of a specific BWP of a third cell;
##the third cell is the cell where CSI on PUCCH is transmitted;
##the specific BWP is UL BWP where CSI on PUCCH is transmitted; ###n is a slot where UE receives a deactivation command for the SCell in PDSCH;
##n+m is a slot indicated for PUCCH transmission with HARQ-ACK information for the PDSCH reception (e.g. slot where HARQ ACK for SCell A/D MAC CE is transmitted)
#at n+h if SCell deactivation is caused by OD_SS_RS MAC CE (e.g. deactivation command in PDCCH);
##h is 3*number of slots per subframe of a specific BWP of a third cell;
##the third cell is the cell where CSI on PUCCH is transmitted;
##the specific BWP is UL BWP where CSI on PUCCH is transmitted;
##n is a slot where UE receives a deactivation command for the SCell in PDCCH;
#at the first slot after slot n+j;
##j is 3*number of slots per subframe of a specific BWP of the SCell;
##the specific BWP is the active DL BWP of the SCell;
##n is a slot when sCellDeactivationTimer associated with the secondary cell expires

### <SCell_status_change_determination>

A OD_SS_RS MAC CE is received at slot n of a first cell (one of one or more specific serving cells) and the OD_SS_RS MAC CE contains information related to a second cell:
#if [SSB indication in a block number M that corresponds to the second sell is set to 0] and [the second cell is activated when OD_SS_RS MAC CE is received (e.g. the second cell is A-SCell];
##UE determines that SSB transmission of the second cell will stop at specific time point of the second cell (or UE determines that SSB of the second cell will be unavailable after specific time point of the second cell);
##UE determines that SCell changes from A-SCell to D2-SCell (e.g. state transition from D1-SCell to D2-SCell occurs).
#if [SSB indication in a block number M that corresponds to the second sell is set to 0] and [the second cell is not activated when OD_SS_RS MAC CE is received] and [the SSB has been transmitted in the second cell before the reception of OD_SS_RS MAC CE (e.g. the second cell is D1-SCell)];
##UE determines that SSB transmission of the second cell will stop at specific time point of the second cell (or UE determines that SSB of the second cell will be unavailable after specific time point of the second cell);
##UE determines that SCell changes from D1-SCell to D2-SCell (e.g. state transition from D1-SCell to D2-SCell occurs).
#if [a block number M that corresponds to the second cell is set to 1] and [the second cell is not activated when OD_SS_RS MAC CE is received] and [the SSB was not transmitted in the second cell before the reception of OD_SS_RS MAC CE (e.g. the SCell is D2-SCell)];
##UE determines that SSB transmission of the second cell will start at specific time point of the second cell (or UE determines that SSB of the second cell will be available after specific time point of the second cell);
##UE determines that the SCell changes from D2-SCell to D1-SCell (e.g. state transition from D2-SCell to D1-SCell occurs).
#if [a block number M that corresponds to a second cell is set to 1] and [the second cell is not activated when OD_SS_RS MAC CE is received] and [the SSB has been transmitted in the second cell before the reception of OD_SS_RS MAC CE (e.g. the second cell is D1-SCell)];
##UE determines that SSB transmission of the second cell does not change (e.g. continue before and after reception of the OD_SS_RS MAC CE); ##UE determines that second cell stay as D1-SCell (e.g. state transition does not occurs).
#if [a block number M that corresponds to a second cell is set to 0] and [the second cell is not activated when OD_SS_RS MAC CE is received] and [the SSB has been transmitted before the reception of OD_SS_RS MAC CE (e.g. the second cell is D2-SCell)];
##UE determines that SSB transmission of the second cell does not change (e.g. no SSB transmission before and after reception of the OD_SS_RS MAC CE);
##UE determines that second cell stay as D2-SCell (e.g. state transition does not occurs).

The specific time point is either slot n+h or determined from SSB time offset.

A SCell A/D MAC CE is received at slot n of a third cell (a serving cell among currently active serving cells) and the SCell A/D MAC CE contains information related to the second cell:
#if [Ci bit that corresponds to the second cell is set to 1] and [the second cell is not activated when the SCell A/D MACE is received] and [the SSB has been transmitted before the reception of SCell A/D MAC CE (e.g. the second cell is D2-SCell)]
##UE determines that SSB transmission of the second cell will start at slot n+k*x+1 of the second cell (or UE determines that SSB of the second cell will be available after slot n+k*x+1 of the second cell);
##UE determines that the SCell changes from D2-SCell to D1-SCell (e.g. state transition from D2-SCell to D1-SCell occurs).

At 795, UE performs, considering the changed status, measurement related operations. UE may perform serving_cell_measurement_operation_adjusted for each SCell.

<serving_cell_measurement_operation_adjusted>
#for each SCell for which servingCellMO is configured, UE performs followings:
##if the SCell was A-SCell or D1-SCell before reception of DCI 2-10; and
##if the SCell becomes D2-SCell due to reception of DCI 2-10 at slot n of a serving cell;
###UE performs followings at slot n+1 of the serving cell:
####stop measuring SS/PBCH blocks of the SCell;
####stop deriving layer 3 filtered RSRP and RSRQ per beam for the SCell (e.g. initialize Mn, Fn and Fn−1 to zero);
####remove the SCell in relevant cellsTriggeredList (to prevent D2-SCell fulfilling leaving condition and triggering measurement report procedure) where the SCell was included.
#if the SCell was D2-SCell; and
##if the SCell becomes D1-SCell due to reception of DCI 2-10 at slot n of a serving cell;
###UE performs followings at slot n+c+y of the SCell:
####start measuring SS/PBCH block of the SCell based on SSB-ToMeasure in the ServingCellConfigCommon of the SCell;
####start deriving filtered RSRP and RSRQ per beam for the SCell (e.g. start updating Fn based on Mn and Fn−1) ##if the SCell becomes A-SCell due to reception of SCell A/D MAC CE at slot n of a serving cell;
###UE performs followings at slot n+m of a serving cell where HARQ ACK is transmitted;
####start measuring SS/PBCH block of the SCell based on SSB-ToMeasure in the ServingCellConfigCommon of the SCell;
####start deriving filtered RSRP and RSRQ per beam for the SCell (e.g. start updating Fn based on Mn and Fn−1)

UE performs evaluation on measurement report triggering. UE performs applicable_cell_determination_after_SCell_status_change to determine applicable cells and neighbouring cells. UE performs determining_whether_to_perform_measurement_reporting_triggering_evaluation_after_S Cell_status_change for measId configured with the first type event. UE performs measurement_report_triggering_evaluation. UE performs measurement_report_triggering_evaluation. UE may perform measurement_report_initiating_on_entering or measurement_report_initiating_on_leaving or both. UE may perform cellTriggeredList_update.

<applicable_cell_determination_after_SCell_status_change>

For first type event: (same as applicable_cell_determination)
#For a measId that is configured with a first type event (alternatively, for each measId, for which the first type event is configured in the corresponding reportConfig):
##UE considers only the serving cell to be applicable for the first event (alternatively, UE consider a specific SCell to be applicable for the event; the specific SCell is the SCell that is associated with a specific measObject; the specific measObject is associated with a specific reportConfig; the reportConfig configures the first type event).

For second type event:
#For a measId that is configured with a second type event (alternatively, for each measId, for which the second type event is configured in the corresponding reportConfig):
##if the concerned measObjectNR (the measObjectNR associated with the measId) is associated with a SCell,
###if the SCell associated with the measObjectNR was A-SCell or D1-SCell before reception of OD_SS_RS MAC CE and becomes D2-SCell due to reception of OD_SS_RS MAC CE; or
###if the SCell associated with the measObjectNR was D2-SCell before reception of OD_SS_RS MAC CE and continues to be D2-SCell due to reception of OD_SS_RS MAC CE,
####UE considers the SCell neither neighbouring cell nor to be applicable.
###if the SCell associated with the measObjectNR was D2-SCell before reception of OD_SS_RS MAC CE and becomes D2-SCell due to reception of OD_SS_RS MAC CE; or
###if the SCell associated with the measObjectNR was A-SCell or D1-SCell before reception of OD_SS_RS MAC CE and continues to be A-SCell or D1-SCell due to reception of OD_SS_RS MAC CE,
####UE considers the SCell to be a neighbouring cell as well;
####if useAllowedCellList is set to true and if the SCell is included in the allowedCellsToAddModList,
#####UE considers the SCell to be applicable.
####if useAllowedCellList is set to true and if the SCell is not included in the allowedCellsToAddModList,
#####UE considers the SCell to be not applicable.
####if useAllowedCellList is set to false and if the SCell is not included in the excludedCellsToAddModList,
#####UE considers the SCell to be applicable.
####if useAllowedCellList is set to false and if the SCell is included in the excludedCellsToAddModList,
#####UE considers the SCell to be not applicable.
###if the SCell associated with the measObjectNR is D2-SCell,
###UE considers the SCell neither neighbouring cell nor to be applicable.

For third type event (same as applicable_cell_determination)
#For a measId that is configured with a third type event (alternatively, for each measId, for which the third type event is configured in the corresponding reportConfig):
##if the concerned measObjectNR (the measObjectNR associated with the measId) is associated with a SCell,
###UE considers the SCell neither neighbouring cell nor to be applicable.
   <determining_whether_to_perform_measurement_report_triggering_evaluation_after_SCell_status_change>

For first type event:
#For a measId that is configured with a first type event (alternatively, for each measId, for which the first type event is configured in the corresponding reportConfig):
##if the applicable cell for the first type event becomes A-SCell or D1-SCell due to reception of OD_SS_RS MAC CE or SCell A/D MAC CE; and
##if the applicable cell was D2-SCell before the reception of DCI2_10 or SCell A/D MAC CE;
###UE determines to start measurement_reporting_triggering_evaluation for the measId;
##if the applicable cell for the first type event becomes D2-SCell due to reception of OD_SS_RS MAC CE; and
##if the applicable cell was D1-SCell or A-SCell before the reception of DCI2_10;
###UE determines to stop measurement_reporting_triggering_evaluation for the measId;
   <cellsTriggeredList_update_after_SCell_status_chagne>

For cells TriggeredList_update_after_SCell_status_change for a measId, UE may:
#if a one or more cells included in the cellsTriggeredList becomes D2-SCell due to reception of OD_SS_RS MAC CE;
##remove the one or more cells in the cellsTriggeredList for the MeasId; and
##not initiate the measurement reporting procedure.
#if the entry condition applicable for the event associated with the measId is fulfilled for one or more cells for all measurements after layer3 filtering taken during timeToTriggered; and
#if the one or more cells are not included in cellTriggeredList:
##include the one or more cells in the cellsTriggeredList for the MeasId; and
##initiate the measurement reporting procedure;
#if the leaving condition applicable for the event associated with the measId is fulfilled for one or more of the cells for all measurements after layer3 filtering taken during timeToTriggered; and
#if the one or more cells are included in cellTriggeredList:
##remove the one or more cells in the cellsTriggeredList for the MeasId; and
##initiate the measurement reporting procedure.

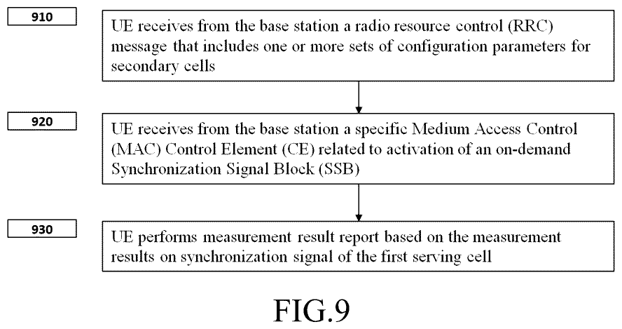

FIG. 9 is a diagram illustrating UE operations for on-demand SSB.

At 910, the UE receives from the base station a radio resource control (RRC) message, wherein the RRC message includes one or more sets of configuration parameters for secondary cells.

At 920, the UE receives from the base station a specific Medium Access Control (MAC) Control Element (CE) related to activation of an on-demand Synchronization Signal Block (SSB).

At 930, the UE determines based on the specific MAC CE activation of the on-demand SSB in a specific secondary cell.

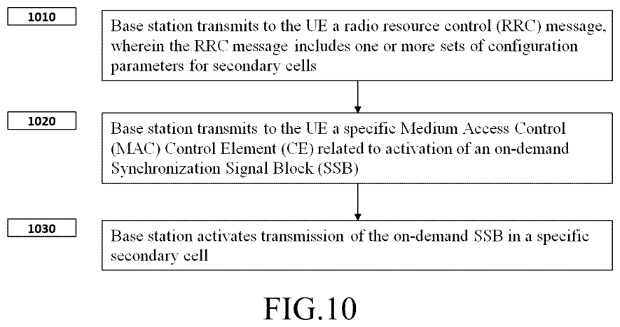

FIG. 10 is a diagram illustrating base station operations for on-demand SSB.

At 1010, the base station transmits to the UE a radio resource control (RRC) message, wherein the RRC message includes one or more sets of configuration parameters for secondary cells.

At 1020, the base station transmits to the UE a specific Medium Access Control (MAC) Control Element (CE) related to activation of an on-demand Synchronization Signal Block (SSB).

At 1030, the base station activates transmission of the on-demand SSB in a specific secondary cell.

The specific secondary cell is determined based on a first information of the specific MAC CE, wherein the first information is associated with a secondary cell index of the specific secondary cell. A specific number of bursts of the on-demand SSBs are transmitted in the secondary cell based on a second information of the specific MAC CE. A specific System Frame Number (SFN) of a primary cell related to transmission time of the on-demand SSB in the secondary cell is determined based on the second information of the specific MAC CE.

The SCell Activation/Deactivation MAC CE of one octet is identified by a MAC subheader with LCID. It has a fixed size and consists of a single octet containing seven C-fields and one R-field. The SCell Activation/Deactivation MAC CE with one octet is defined. The SCell Activation/Deactivation MAC CE of four octets is identified by a MAC subheader with LCID. It has a fixed size and consists of four octets containing 31 C-fields and one R-field. The SCell Activation/Deactivation MAC CE of four octets is defined as follows
#Cᵢ: If there is an SCell configured for the MAC entity with SCellIndex i this field indicates the activation/deactivation status of the SCell with SCellIndex i, else the MAC entity shall ignore the Cᵢ field. The Cᵢ field is set to 1 to indicate that the SCell with SCellIndex i shall be activated. The Cᵢ field is set to 0 to indicate that the SCell with SCellIndex i shall be deactivated;
#R: Reserved bit, set to 0.

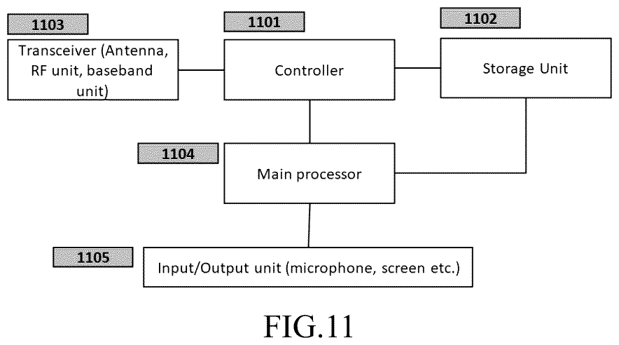

FIG. 11 is a block diagram illustrating the internal structure of a Terminal to which the disclosure is applied.

Referring to the diagram, the terminal includes a controller (1101), a storage unit (1102), a transceiver (1103), a main processor (1104) and I/O unit (1105).

The controller (1101) controls the overall operations of the terminal in terms of mobile communication. For example, the controller (1101) receives/transmits signals through the transceiver (1103). In addition, the controller (1101) records and reads data in the storage unit (1102). To this end, the controller (1101) includes at least one processor. For example, the controller (1101) may include a communication processor (CP) that performs control for communication and an application processor (AP) that controls the upper layer, such as an application program. The controller controls storage unit and transceiver such that UE operations illustrated in this disclosure are performed.

The storage unit (1102) stores data for operation of the terminal, such as a basic program, an application program, and configuration information. The storage unit (1102) provides stored data at a request of the controller (1101).

The transceiver (1103) consists of a RF processor, a baseband processor and plurality of antennas. The RF processor performs functions for transmitting/receiving signals through a wireless channel, such as signal band conversion, amplification, and the like. Specifically, the RF processor up-converts a baseband signal provided from the baseband processor into an RF band signal, transmits the same through an antenna, and down—converts an RF band signal received through the antenna into a baseband signal. The RF processor may include a transmission filter, a reception filter, an amplifier, a mixer, an oscillator, a digital-to-analog converter (DAC), an analog-to-digital converter (ADC), and the like. The RF processor may perform MIMO and may receive multiple layers when performing the MIMO operation. The baseband processor performs a function of conversion between a baseband signal and a bit string according to the physical layer specification of the system. For example, during data transmission, the baseband processor encodes and modulates a transmission bit string, thereby generating complex symbols. In addition, during data reception, the baseband processor demodulates and decodes a baseband signal provided from the RF processor, thereby restoring a reception bit string.

The main processor (1104) controls the overall operations other than mobile operation. The main processor (1104) process user input received from I/O unit (1105), stores data in the storage unit (1102), controls the controller (1101) for required mobile communication operations and forward user data to I/O unit (1105).

I/O unit (1105) consists of equipment for inputting user data and for outputting user data such as a microphone and a screen. I/O unit (1105) performs inputting and outputting user data based on the main processor's instruction.

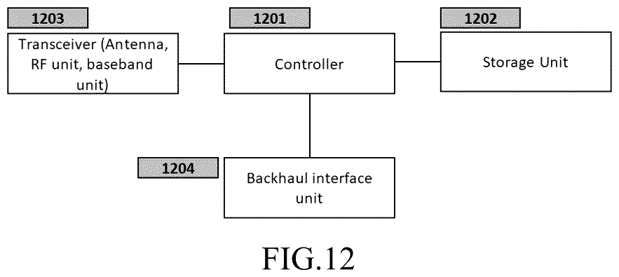

FIG. 12 is a block diagram illustrating the configuration of a base station according to the disclosure.

As illustrated in the diagram, the base station includes a controller (1201), a storage unit (1202), a transceiver (1203) and a backhaul interface unit (1204).

The controller (1201) controls the overall operations of the main base station. For example, the controller (1201) receives/transmits signals through the transceiver (1203), or through the backhaul interface unit (1204). In addition, the controller (1201) records and reads data in the storage unit (1202). To this end, the controller (1201) may include at least one processor. The controller controls transceiver, storage unit and backhaul interface such that base station operation illustrated in FIG. 10 are performed.

The storage unit (1202) stores data for operation of the main base station, such as a basic program, an application program, and configuration information. Particularly, the storage unit (1202) may store information regarding a bearer allocated to an accessed UE, a measurement result reported from the accessed UE, and the like. In addition, the storage unit (1202) may store information serving as a criterion to determine whether to provide the terminal with multi-connection or to discontinue the same. In addition, the storage unit (1202) provides stored data at a request of the controller (1201).

The transceiver (1203) consists of a RF processor, a baseband processor and plurality of antennas. The RF processor performs functions for transmitting/receiving signals through a wireless channel, such as signal band conversion, amplification, and the like. Specifically, the RF processor up-converts a baseband signal provided from the baseband processor into an RF band signal, transmits the same through an antenna, and down-converts an RF band signal received through the antenna into a baseband signal. The RF processor may include a transmission filter, a reception filter, an amplifier, a mixer, an oscillator, a DAC, an ADC, and the like. The RF processor may perform a down link MIMO operation by transmitting at least one layer. The baseband processor performs a function of conversion between a baseband signal and a bit string according to the physical layer specification of the first radio access technology. For example, during data transmission, the baseband processor encodes and modulates a transmission bit string, thereby generating complex symbols. In addition, during data reception, the baseband processor demodulates and decodes a baseband signal provided from the RF processor, thereby restoring a reception bit string.

The backhaul interface unit (1204) provides an interface for communicating with other nodes inside the network. The backhaul interface unit (1204) converts a bit string transmitted from the base station to another node, for example, another base station or a core network, into a physical signal, and converts a physical signal received from the other node into a bit string.

Below lists acronym used in the present disclosure.
5GC 5G Core Network RACH Random Access Channel
ACK Acknowledgement RAN Radio Access Network
AM Acknowledged Mode RAR Random Access Response
AMF Access and Mobility Management Function
RA-RNTI Random Access RNTI
ARQ Automatic Repeat Request RAT Radio Access Technology
AS Access Stratum RB Radio Bearer
ASN.1 Abstract Syntax Notation One RLC Radio Link Control
BSR Buffer Status Report RNA RAN-based Notification Area
BWP Bandwidth Part RNAU RAN-based Notification Area Update
CA Carrier Aggregation RNTI Radio Network Temporary Identifier
CAG Closed Access Group RRC Radio Resource Control
CG Cell Group RRM Radio Resource Management
C-RNTI Cell RNTI RSRP Reference Signal Received Power
CSI Channel State Information RSRQ Reference Signal Received Quality
DCI Downlink Control Information RSSI Received Signal Strength Indicator
DRB (user) Data Radio Bearer SCell Secondary Cell
DTX Discontinuous Reception SCS Subcarrier Spacing
HARQ Hybrid Automatic Repeat Request
SDAP Service Data Adaptation Protocol
IE Information element SDU Service Data Unit
LCG Logical Channel Group SFN System Frame Number
MAC Medium Access Control S-GW Serving Gateway
MIB Master Information Block SI System Information
NAS Non-Access Stratum SIB System Information Block
NG-RAN NG Radio Access Network SpCell Special Cell
NR NR Radio Access SRB Signalling Radio Bearer
PBR Prioritised Bit Rate SRS Sounding Reference Signal
PCell Primary Cell SS Search Space
PCI Physical Cell Identifier SSB SS/PBCH block
PDCCH Physical Downlink Control Channel
SSS Secondary Synchronisation Signal
PDCP Packet Data Convergence Protocol SUL Supplementary Uplink
PDSCH Physical Downlink Shared Channel
TM Transparent Mode
PDU Protocol Data Unit UCI Uplink Control Information
PHR Power Headroom ReportUE User Equipment
PLMN Public Land Mobile Network UM Unacknowledged Mode
PRACH Physical Random Access Channel
CRP Cell Reselection Priority
PRB Physical Resource Block PSS Primary Synchronisation Signal
PUCCH Physical Uplink Control Channel
PUSCH Physical Uplink Shared Channel

What is claimed is:

1. A method performed by a terminal, the method comprising:
receiving, by the terminal from a base station, a radio resource control (RRC) message, wherein the RRC message comprises one or more sets of configuration parameters for secondary cells;
receiving, by the terminal from the base station, a specific Medium Access Control (MAC) Control Element (CE) related to activation of an on-demand Synchronization Signal Block (SSB); and
determining, by the terminal based on the specific MAC CE, activation of the on-demand SSB in a specific secondary cell,
wherein:
the specific secondary cell is determined based on first information of the specific MAC CE, the first information being associated with a secondary cell index of the specific secondary cell;
a specific number of on-demand SSBs are transmitted in the secondary cell, the specific number being determined based on second information of the specific MAC CE; and
at least one of the on-demand SSBs is transmitted in the specific secondary cell at a specific System Frame Number (SFN), the specific SFN being determined based on the second information of the specific MAC CE.

2. A terminal in a wireless communication system, the terminal comprising:
a transceiver configured to transmit and receive signals; and
a controller configured to control the transceiver to:
receive, from a base station, a radio resource control (RRC) message, wherein the RRC message comprises one or more sets of configuration parameters for secondary cells;
receive, from the base station, a specific Medium Access Control (MAC) Control Element (CE) related to activation of an on-demand Synchronization Signal Block (SSB); and
determine, based on the specific MAC CE, activation of the on-demand SSB in a specific secondary cell,
wherein:
the specific secondary cell is determined based on first information of the specific MAC CE, the first information being associated with a secondary cell index of the specific secondary cell;
a specific number of on-demand SSBs are transmitted in the secondary cell, the specific number being determined based on second information of the specific MAC CE; and
at least one of the on-demand SSBs is transmitted in the specific secondary cell at a specific System Frame Number (SFN), the specific SFN being determined based on the second information of the specific MAC CE.

3. A method performed by a base station, the method comprising:
transmitting, by the base station to a terminal, a radio resource control (RRC) message, wherein the RRC message comprises one or more sets of configuration parameters for secondary cells;
transmitting, by the base station to the terminal, a specific Medium Access Control (MAC) Control Element (CE) related to activation of an on-demand Synchronization Signal Block (SSB); and
performing, by the base station based on the specific MAC CE, activation of the on-demand SSB in a specific secondary cell,
wherein:
the specific secondary cell is determined based on first information of the specific MAC CE, the first information being associated with a secondary cell index of the specific secondary cell;
a specific number of bursts of on-demand SSBs are transmitted in the secondary cell, the specific number being determined based on second information of the specific MAC CE; and
at least one of the on-demand SSBs is transmitted in the specific secondary cell at a specific System Frame Number (SFN), the specific SFN being determined based on the second information of the specific MAC CE.

4. The method of claim 1, wherein:
the on-demand SSB in the specific secondary cell is activated at a specific point in time; and
the specific point in time is determined based on:
subcarrier spacing of a specific bandwidth part of the specific secondary cell; and
a parameter for SSB position in a burst.

5. The method of claim 1,
wherein a periodicity of the on-demand SSB is determined based on the second information.

6. The method of claim 5, wherein the second information is associated with:
a field related to a specific part of SFN;
a field related to the number of SSB bursts; and
a field related to transmission periodicity.

7. The method of claim 6, wherein:
the specific number of the on-demand SSBs to be transmitted in the secondary cell is determined based on the field related to the number of SSB bursts;
the specific SFN in which the at least one of the on-demand SSBs is transmitted is determined based on the field related to the specific part of SFN; and
the periodicity of the on-demand SSB is determined based on the field related to transmission periodicity.
